(19) United States
(12) Patent Application Publication
(10) Pub. No.: US 2025/0112732 A1
(43) Pub. Date: Apr. 3, 2025

(54) FRAME NUMBER OFFSET FOR POSITIONING OF A REMOTE UE

(71) Applicant: MEDIATEK INC., Hsinchu City (TW)

(72) Inventors: Nathan Edward TENNY, San Jose, CA (US); Xuelong WANG, Beijing (CN); Tao CHEN, Beijing (CN); Chiao-Yao CHUANG, Hsinchu City (TW)

(21) Appl. No.: 18/834,214

(22) PCT Filed: May 9, 2023
(86) PCT No.: PCT/CN2023/092910

§ 371 Date: Jul. 29, 2024

(30) Foreign Application Priority Data
Jun. 9, 2022 (WO) PCT/CN2022/097870

(51) Int. Cl. H04L 1/1607; H04W 56/00; H04W 72/25; H04W 76/20; H04W 92/18

(52) U.S. Cl. CPC H04L 1/1642; H04W 56/0015; H04W 72/25; H04W 76/20; H04W 92/18

(57) ABSTRACT

A method can include receiving a system frame number (SFN) from a base station by a first relay UE, determining a timeline of the SFN based on one or more synchronization signals by the first relay UE, determining a timeline of a direct frame number (DFN) based on a reference time source by the first relay UE, computing an SFN-DFN offset based on the difference between the timeline of the SFN and the timeline of the DFN by the first relay UE, and transmitting the SFN-DFN offset and the DFN to a receiving UE on a sidelink interface.

### INCORPORATION BY REFERENCE

This present application claims the benefit of International Application No. PCT/CN2022/097870, “Frame Number Offset for Positioning of a Remote UE” filed on Jun. 9, 2022, which is incorporated herein by reference in its entirety.

### TECHNICAL FIELD

This disclosure relates to wireless communications, and specifically to methods of determining the location of a remote UE receiving service from a cellular network via a relay UE.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Sidelink communication technologies enable direct communication between two devices without the participation of a base station in the transmission and reception of data traffic. Sidelink communication can be used to extend the service of a cellular network to a mobile device beyond the coverage of the base stations.

### SUMMARY

Aspects of the disclosure provide a method. The method can include receiving a system frame number (SFN) from a base station by a first relay UE, determining a timeline of the SFN based on one or more synchronization signals by the first relay UE, determining a timeline of a direct frame number (DFN) based on a reference time source by the first relay UE, computing an SFN-DFN offset based on the difference between the timeline of the SFN and the timeline of the DEN by the first relay UE, and transmitting the SFN-DFN offset and the DEN to a receiving UE on a sidelink interface.

In an embodiment, the receiving UE is a remote UE. In an embodiment, the receiving UE is a second relay UE. In an embodiment, the SFN-DFN offset is transmitted in a message of a PC5 radio resource control (PC5-RRC) protocol. In an embodiment, the message is an RRCReconfigurationSidelink message. n an embodiment, the message is an UEAssistanceInformationSidelink message. In an embodiment, the SFN-DFN offset comprises at least one of a frame-level offset, a subframe-level offset, and a slot-level offset. In an embodiment, the SFN-DFN offset is transmitted in a medium access control (MAC) control element (CE) of a PC5 MAC protocol. In an embodiment, the SFN-DFN offset is transmitted in a sidelink control information (SCI) transmission.

Aspects of the disclosure provide an apparatus comprising circuitry. The circuitry is configured to receive a system frame number (SFN) from a base station by a first relay UE, determine a timeline of the SFN based on one or more synchronization signals by the first relay UE, determine a timeline of a direct frame number (DFN) based on a reference time source by the first relay UE, compute an SFN-DFN offset based on the difference between the timeline of the SFN and the timeline of the DFN by the first relay UE, and transmit the SFN-DFN offset and the DEN to a receiving UE on a sidelink interface.

Aspects of the disclosure provide a non-transitory computer-readable medium storing instructions that, when executed by a processor, cause the processor to perform the method.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an example of a communication operation between a relay UE 101 and a remote UE 102.

FIG. 2 shows an example of downlink positioning for a UE 201 out of coverage.

FIG. 3 shows an exemplary system 300 in which a remote UE 301 is being positioned.

FIG. 4 shows a system 400 in which the SFN-DFN offset is signaled to a remote UE 401 by a relay UE 402.

FIG. 5 shows a system 500 employing multi-hop relaying.

FIG. 6 shows the maintenance of SFN-DFN offsets and the SFN timeline in a multi-hop environment.

FIG. 7 shows a process 700 of SFN-DFN offset signaling between a relay UE and a remote UE.

FIG. 8 shows an exemplary apparatus 800 according to embodiments of the disclosure.

### DETAILED DESCRIPTION OF EMBODIMENTS

In certain cellular systems, such as 3GPP 5G New Radio (NR) from Rel-17 onward, a first user equipment (UE) may function in a relaying relationship with a second UE. For example, the first UE may be out of direct cellular coverage or in poor coverage, while the second UE is in good coverage, and the second UE may deliver communications between the first UE and the serving cellular network. In this scenario, the first UE may be referred to as a remote UE and the second UE may be referred to as a relay UE. The remote UE may be referred to as being in “indirect service” or having an “indirect path” to the network, while the relay UE may be referred to as being in “direct service” or having a “direct path” to the network. The relay and remote UEs may communicate via a sidelink interface, also called a PC5 interface, in which radio resources are used for direct communication between UEs without an intervening network node. This PC5 interface is contrasted with a Uu interface between a UE and a network node, which is used for conventional direct service. In the ordinary course of direct cellular service, a UE is aware of the system timing of the serving node, such as an eNode B (eNB) or gNode B (gNB). The system timing is represented by a system frame number (SFN), representing an essentially arbitrary time reference point for the serving cell. The timeline of the cell is divided into frames of a consistent length (for example, 10 ms), and the frame is subdivided into subframes of a consistent length (for example, 1 ms). Depending on the numerology of the radio configuration of the cell, the subframe may be further subdivided into slots of a consistent length, for example, 0.25 ms when the serving carrier has a subcarrier spacing of 60 kHz. Each frame is assigned an SFN, in a cycle of fixed length, for example, a cycle of 1024 frames starting at SFN #0, resulting in a range of SFN values from 0 to 1023. This structure allows the UE to have an unambiguous time reference for events on the radio interface. For example, a periodically occurring radio configuration may be described as occurring at SFN #x with a periodicity of N frames, meaning that the configuration occurs in SFNs x, x+N, x+2N, x+3N, and so on.

There are many scenarios in which it is desirable to know the location of a UE, such as for an emergency call, location-based services, network optimization, and so on. For a UE in direct service, the system may exploit timing or directional information about the cellular air interface to determine the location of the UE. As one example, the UE may measure the relative timing of signals arriving from a plurality of transmit points (TPs) of the network to determine the time difference of arrival (TDOA) values for a plurality of pairs of TPs. A TP may also be capable of reception and may accordingly be described as a transmit-receive point (TRP). In the context of downlink positioning, only the transmission function is relevant. The determined TDOA values may then be used, at a position calculation entity that may be located in the UE or in a network node such as a location management function (LMF) or Secure User Plane Location (SUPL) location platform (SLP), to determine an approximate location for the UE, according to well-known methods. As another example, the UE may receive signals from specific beams transmitted by a plurality of TPs, and measurement information on the beams may be combined, by the position calculation entity, with angular information describing the directions of transmission of the beams and with location information of the TPs to determine an approximate location for the UE, again according to well-known methods. These methods of positioning may be described as downlink time difference of arrival (DL-TDOA) and downlink angle of departure (DL-AoD) positioning methods, respectively. The downlink measurements that facilitate these positioning methods may be taken over a set of downlink positioning reference signals (DL-PRS), sometimes shortened to positioning reference signals (PRS) when the direction of transmission is unambiguous. The DL-PRS transmissions from the TPs may be configured in a coordinated way, and their configurations may be provided to the UE in the form of assistance data to allow the UE to measure the DL-PRS transmissions.

This disclosure is directed to the establishment of a system timeline facilitating the use of downlink positioning when the UE to be positioned is operating as a remote UE.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

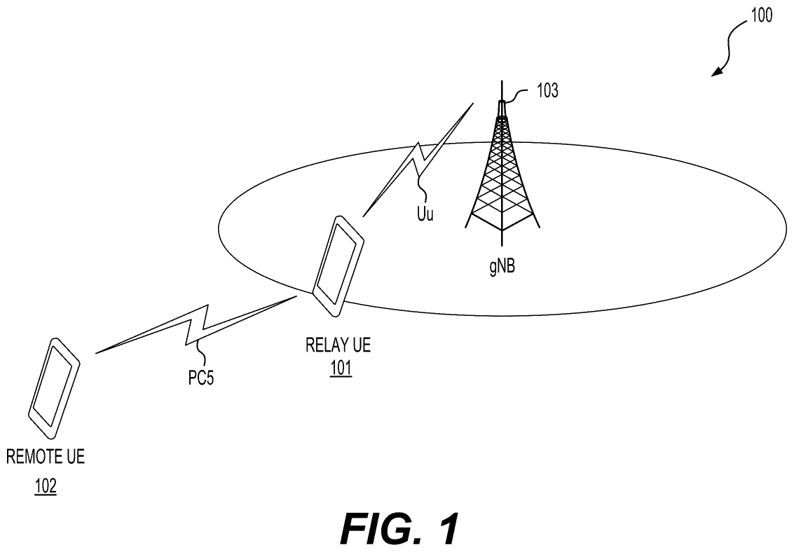

FIG. 1 shows an example of a communication operation between a relay UE 101 and a remote UE 102. A cellular system 100 comprises a base station 103 (e.g., a gNB as shown in the figure), a relay UE 101, and a remote UE 102. The base station 100 can communicate on a Uu interface with the relay UE 101, and the relay UE 101 can communicate on a PC5 interface with the remote UE 102. Communications between the remote UE 102 and the base station 103 can be relayed by the relay UE 101. The relaying may use various protocol architectures, such as a layer 2 relaying architecture or a layer 3 relaying architecture.

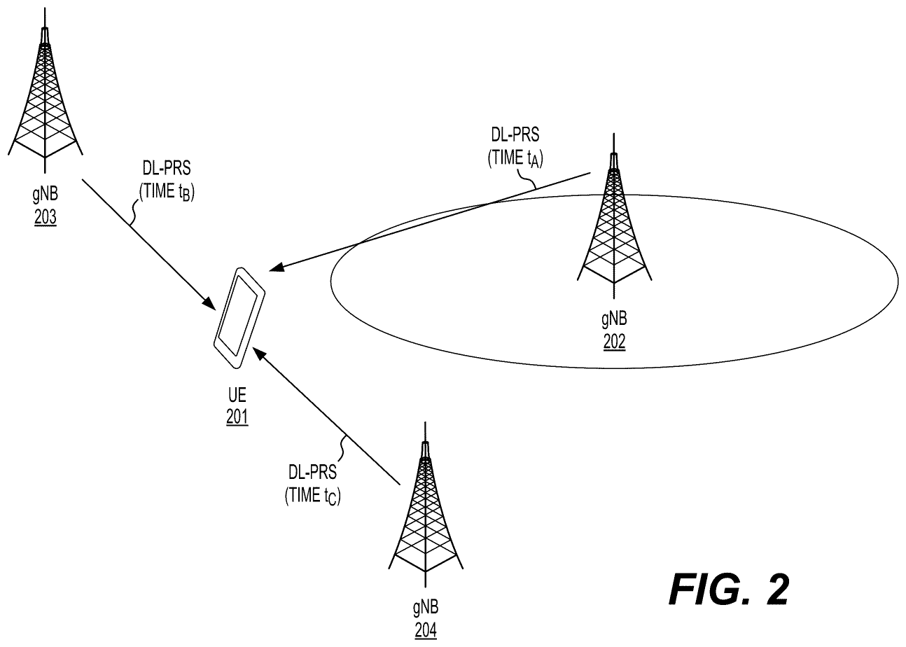

FIG. 2 shows an example of downlink positioning for a UE 201 out of coverage. As shown in FIG. 2, the UE 201 is not in good enough radio conditions to be served by any of gNB 202, 203, and 204. However, because the DL-PRS transmissions are designed for hearability, the UE 201 may be able to detect and measure DL-PRS transmissions from the gNBs. In particular, the UE 201 may detect a DL-PRS transmission from gNB 202 at time t_{A}, a DL-PRS transmission from gNB 203 at time t_{B}, and a DL-PRS transmission from gNB 204 at time t_{C}. From these arrival times, and from knowledge of the relative times of transmission of the DL-PRS from the various gNBs, the UE 201 can determine time difference of arrival (TDOA) values. For instance, if gNB 202 and gNB 203 transmit their DL-PRS at substantially the same instant, for example, in a synchronous deployment where all gNBs use the same timeline, the TDOA between the signals from gNB 202 and the signals from gNB 203 is t_{B}-t_{A}. If the transmissions are not simultaneous, for example, if gNB 202 and gNB 203 are operating on independent timelines, or if their DL-PRS configurations have different periodicities and/or offsets with respect to the respective SFN timelines, the computed TDOA needs to be adjusted to account for the difference in transmit timing. This adjustment is a well-known aspect of DL-TDOA positioning.

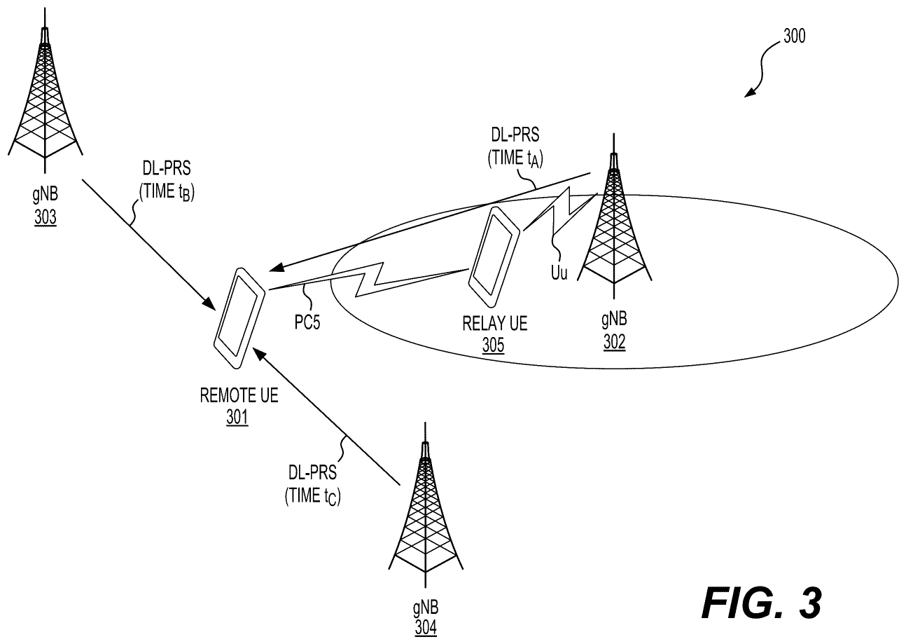

FIG. 3 shows an exemplary system 300 in which a remote UE 301 is being positioned. When a UE to be positioned is functioning as a remote UE 301, as shown in FIG. 3 it may be able to receive and measure DL-PRS transmissions from one or more nearby transmit points (TPs), even though the remote UE 301 may be in poor coverage or out of coverage from the standpoint of direct communication with the cellular network. For example, the remote UE 301 can receive DL-PRS transmissions from TPs associated with gNBs 302, 303, and 304, even though it is not in coverage for direct cellular service on any of the gNBs. As shown in FIG. 3, the remote UE 301 can communicate indirectly with gNB 302 via a relay UE 305, and through this indirect communication, it is possible for the network to deliver assistance data to the remote UE 301 and for the remote UE 301 to deliver measurements to the network. For example, to facilitate UE-assisted positioning where the UE's location estimate is computed at an LMF or an SLP. The exchange of assistance data and measurements may take place via a positioning protocol, such as the LTE positioning protocol (LPP), SUPL, and so on. Thus, it may be possible to use downlink positioning methods (such as DL-TDOA and DL-AoD) to position the remote UE 301. Similar to the measurements in FIG. 2, the remote UE 301 may measure times of arrival t_{A}, t_{B}, and t_{C}, and compute the TDOA values corresponding to the times of arrival. However, in order to measure DL-PRS for positioning, the remote UE must be able to interpret the DL-PRS configurations provided to it, for example, as part of the assistance data, and in some embodiments, these configurations may depend on the information that in the existing art is provided via a direct path from the cellular network.

As one example, DL-PRS configurations may have a dependency on the system frame number (SFN) of the frame in which they occur. The DL-PRS may be provided from a TP on a periodic basis, with the periodicity defined relative to the SFN cycle. Accordingly, the UE may need to know the SFN of the cell from which it measures DL-PRS, and configuration information may be provided as part of the assistance data to facilitate this knowledge. For example, an SFN offset for a neighbor cell to be measured may be included in the assistance data, describing the SFN timeline of the neighbor cell relative to the SFN of an assistance data reference cell. The assistance data reference cell may be the UE's serving cell. In the event that the assistance data reference cell is different from the UE's serving cell, well-known methods exist for enabling the UE to determine the SFN of the cells in the assistance data, provided the assistance data include at least one cell for which the UE can obtain the SFN. This one cell need not be the same as the assistance data reference cell nor as the UE's serving cell.

However, if the UE to be positioned is a remote UE, such as the remote UE 301 shown in FIG. 3, it does not have access through the direct path to the SFN of the serving cell, and it may not be able to determine directly the SFN of any cell. In the existing art on the Uu interface, the SFN of the serving cell is provided as part of the Master Information Block (MIB) sent by the serving cell, and a UE in direct service is expected to associate the SFN correctly with the frame boundaries that it detects in the transmissions from the cell (based on timing derived from synchronization signals, for example). A UE in indirect service cannot perform this association, since it does not receive synchronization signals from the cell, does not detect frame boundaries, and is not aware of the SFN (in the existing art, the MIB is not forwarded to the remote UE). Accordingly, additional information may be needed for the remote UE to determine the SFN of its (indirect) serving cell. Moreover, the remote UE may need to know when the frame boundary occurs in the serving cell, and it may need to report measurements or other positioning-related information with a timestamp to a particular time granularity. For example, in LPP, the information element (IE) NR-TimeStamp-r16 (defined in 3GPP TS 37.355) identifies the timing of the UE's serving cell to slot granularity. Accordingly, there may be a need to provide the remote UE with the SFN value, the timing of the frame boundary, and/or the slot timing, all with respect to the relay UE's serving cell.

Timing on the sidelink interface is defined by a Direct Frame Number (DFN), which is assigned by the transmitting UE. For example, the relay UE in correspondence with the remote UE may provide a DFN as part of the MasterInformationBlockSidelink message. The DFN determines the frame number in which the sidelink synchronization signal block (S-SSB) is transmitted, and the S-SSB allows the receiving UE (in this case, the remote UE) to detect the frame boundary. In consequence, it may be assumed that the remote UE knows the DFN and the frame boundary timing on the sidelink interface, as provided by the relay UE.

The DFN indicated by the relay UE may be computed by a variety of methods, depending on the synchronization source used by the relay UE. For example, if the relay UE is synchronized to a global navigation satellite system (GNSS), the DFN may be derived from GNSS time by a formula (see for instance section 5.8.12 of 3GPP TS 38.331). A similar formula may be used to determine the subframe and slot timing of the PC5 interface. If the relay UE is synchronized to the serving cell, the DFN, the associated subframe, and slot timing may be derived directly from the SFN and other timing information on the Uu interface. In some cases, the relay UE may be synchronized to the serving gNB and align its DFN timeline with the SFN timeline. However, the remote UE may not be able to detect the synchronization in these cases since the remote UE does not have direct knowledge of the synchronization source of the relay UE.

Meanwhile, the relay UE may be in direct service, and thus be aware of the SFN, the frame boundary timing, and/or the slot timing provided by the serving base station. The radio frame size may be identical on the sidelink and Uu interfaces (for instance, 10 ms), meaning that the SFN on the Uu interface and the DEN on the sidelink interface are related by an offset. In an embodiment, this SFN-DFN offset may be signaled to the remote UE by the relay UE. In another embodiment, the SFN-DFN offset may be reported by the relay UE to the base station via signaling (e.g., a SidelinkUEInformation message of an RRC protocol), and the SFN-DFN offset may be signaled by the base station (for instance, via a Uu RRC message) over the indirect path to the remote UE. However, the embodiment in which the offset is signaled to the remote UE by the relay UE may be preferred since the relay UE uniquely has direct knowledge of both the SFN and DFN timelines. It is noted that significant drift in the value of the offset would not be anticipated, since the relay UE maintains awareness of the timeline of the serving cell and can keep the DFN timeline consistent with the serving cell's SFN timeline. However, if the SFN-DFN offset does drift over time or change, the relay UE may transmit a new value of the SFN-DFN offset to the remote UE.

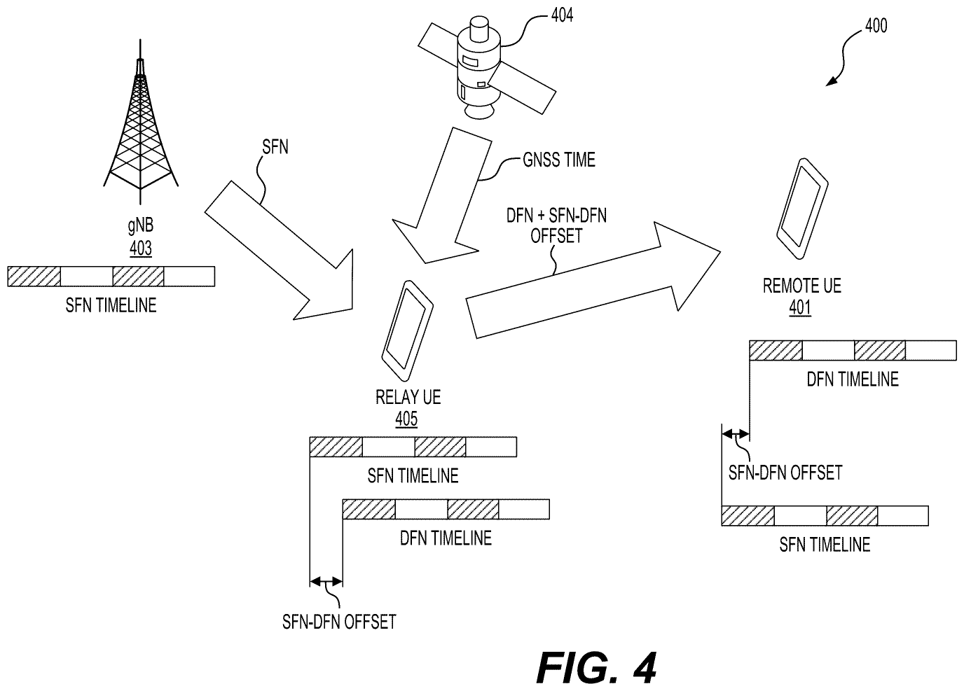

FIG. 4 shows a system 400 in which the SFN-DFN offset is signaled to a remote UE 401 by a relay UE 402. The figure shows a remote UE 401 in communication with a relay UE 402. The relay UE 402 is in direct communication with a serving base station gNB 403 operating a serving cell. The serving cell comprises one or more TPs (not shown in the figure). The serving cell within the gNB 403 maintains an SFN timeline and the relay UE 402 maintains a DFN timeline. The relay UE 402 can derive an SFN-DFN offset from its knowledge of the SFN and DFN timelines. The relay UE 402 can signal the SFN-DFN offset to the remote UE 401. The remote UE 401 can determine the SFN timeline by applying the SFN-DFN offset to the DEN timeline. The SFN-DFN offset may comprise one or more offset values of various granularities, including, for instance, a frame-level offset expressed in units of radio frames (for example, 10-ms units), a subframe-level offset expressed in units of subframes (for example, 1-ms units), a slot-level offset expressed in units of slots (for example, units smaller than a subframe and derived from the carrier numerology), and so on.

In some embodiments, the SFN-DFN offset may also comprise an indication of the carrier numerology in use between the relay UE 402 and the serving cell. This may be necessary, for instance, to facilitate correct interpretation by the remote UE 401 of a slot offset signaled as part of the SFN-DFN offset. In particular, the slot offset may rely on joint signaling to indicate the carrier numerology and a corresponding slot offset, whose range may depend on the indicated carrier numerology. The SFN-DFN offset may be signaled in any message carried on the PC5 interface, such as a MasterInformationBlockSidelink message, an RRCReconfigurationSidelink message, a UEAssistanceInformationSidelink message, a new message specific to updating the timing information, and so on.

In an embodiment, this SFN-DFN offset may be signaled via a PC5 medium access control (MAC) control element (CE) or a sidelink control information (SCI) to the remote UE 401 by the relay UE 402. In another embodiment, this SFN-DFN offset may be signaled via a relay discovery message over PC5 to the remote UE 401 by the relay UE 402. In an additional embodiment, this SFN-DFN offset may be signaled together with one or more positioning system information blocks (posSIBs) over the PC5 interface to the remote UE 401 by the relay UE 402. The SFN-DFN offset may be signaled as an optional field of a message, with specified behavior by the remote UE 401 when the optional field is absent. As one example, the remote UE 401 may assume that the SFN-DEN offset is zero (that is, the SFN and DEN timelines are substantially aligned) when the optional field is not provided. Alternatively, the relay UE 402 may provide an explicit indication when the SFN and DEN timelines are substantially aligned, such as a boolean flag, a zero value for the signaled SFN-DFN offset, and so on.

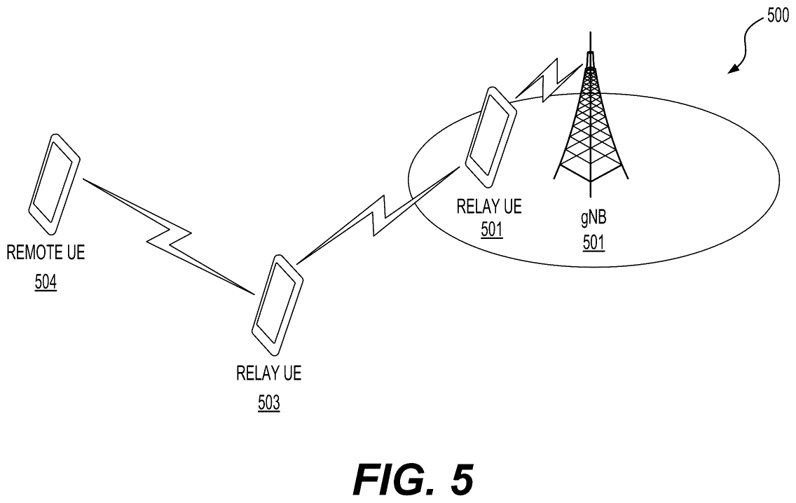

FIG. 5 shows a system 500 employing multi-hop relaying. A gNB 501 is in direct communication with a first UE, acting as a relay UE 502, on a Uu interface. As such, the relay UE 502 is in direct service. The relay UE 502 can serve a second UE, acting as a relay UE 503, over a PC5 interface. As shown in the figure, relay UE 503 may be out of direct coverage of the gNB 501, and therefore relay UE 503 may not be able to operate in direct service. Finally, relay UE 503 serves a remote UE 504 over a PC5 interface. Communications between the gNB 501 and the remote UE 504 traverse relay UE 502 and relay UE 503, according to a relaying architecture that may be implemented in various ways (for instance, a layer 2 or layer 3 relaying architecture).

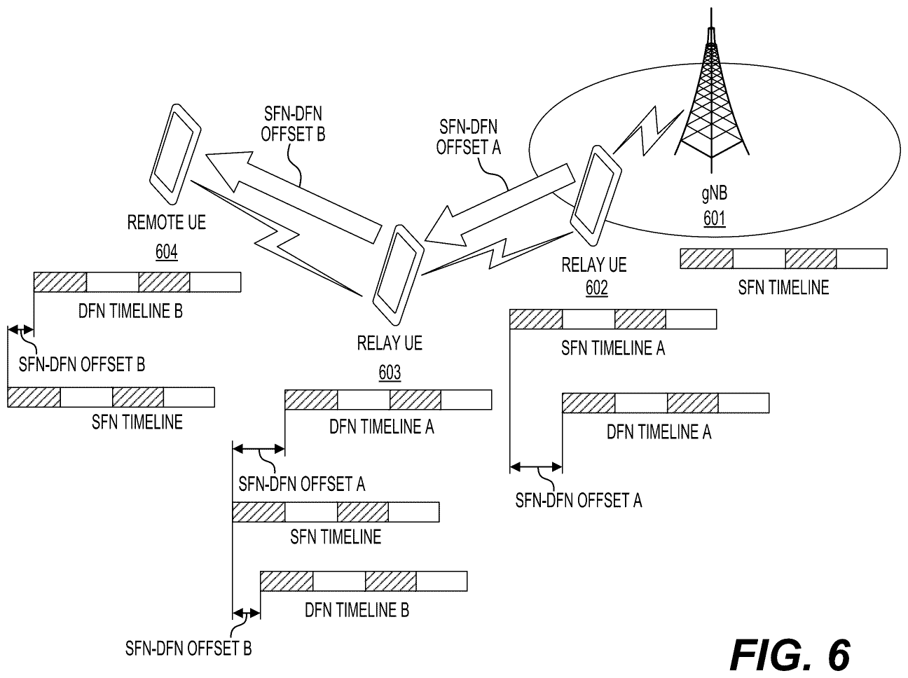

FIG. 6 shows the maintenance of SFN-DFN offsets and the SFN timeline in a multi-hop environment comprising a gNB 601, a relay UE 602, a relay UE 603, and a remote UE 604. The gNB 601 maintains an SFN timeline and transmits its SFN as usual. Because the relay UE 602 is in direct service, the relay UE 602 knows the SFN timeline. The relay UE 602 derives its own DFN timeline A (for example, based on GNSS time), and derives SFN-DFN offset A as described above. Relay UE 602 transmits DFN timeline A (for example, in the MasterInformationBlockSidelink message), and relay UE 602 also delivers to relay UE 603 the computed value of SFN-DFN offset A, using any of the methods previously described. From this information, relay UE 603 can determine the SFN timeline by applying the received SFN-DFN offset A to the DEN timeline A.

Relay UE 603 can further maintain its own DFN timeline B, which may be the same as or different from DEN timeline A. (For example, relay UEs A and B may be synchronized to different sources.) Since the relay UE 603 knows both the SFN timeline and DEN timeline B, the relay UE 603 can derive an SFN-DFN offset B using the methods described above. The relay UE 603 can then transmit DFN timeline B (for example, in the MasterInformationBlockSidelink message), and relay UE 703 also delivers to the remote UE 604 the computed value of SFN-DFN offset B, using any of the methods previously described. From this information, the remote UE 604 can determine the SFN timeline by applying the received SFN-DFN offset B to the DFN timeline B.

In a multi-hop environment, if a remote UE can receive the timing information (e.g., DEN timeline and SFN-DFN offset) from two or more relay UEs, the remote UE may prioritize the timing information during positioning from the relay UE with fewer hops to the serving cell. For example, refer to FIG. 6, the remote UE may prioritize the timing information from the relay UE 602 over the timing information from the relay UE 603 if both can be received. In a multi-hop and multiple path environment, if a remote UE can receive the direct timing information (i.e., the SFN timeline) from a cell (for example, the serving cell) and the indirect timing information (e.g., DEN timeline and SFN-DFN offset) from one or more relay UEs, the remote UE may prioritize the timing information from the cell over any indirect timing information from the one or more relay UEs.

In some embodiments, sidelink communication between the remote and relay UEs may operate on a plurality of sidelink frequencies or carriers, referred to as multi-carrier operation or carrier aggregation (CA). In such a case, it may be necessary for the remote UE to determine which sidelink frequency the received SFN-DFN offset relates to (for instance, if the sidelink frequencies have independent timelines). Accordingly, the relay UE may indicate a frequency identifier along with the signaled SFN-DFN offset, indicating which sidelink frequency the offset corresponds to. This frequency identifier may take the form of an absolute radio frequency channel number (ARFCN), an index, and so on. (In an NR system, an ARFCN may be referred to as an NR-ARFCN, for disambiguation from other systems using similar terminology.) Similarly, Uu communication between the relay UE and the gNB may operate in a CA configuration, and in this case, the relay UE may indicate which Uu frequency the offset corresponds to.

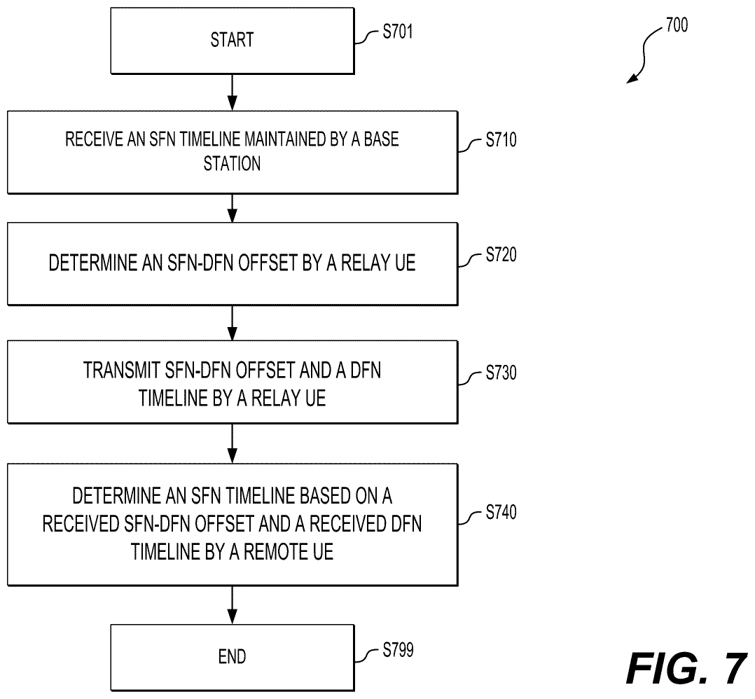

FIG. 7 shows a process 700 of SFN-DFN offset signaling between a relay UE and a remote UE. The process 700 can start from S701 and proceed to S710.

At S710, an SFN timeline can be received by a relay UE from a base station. The SFN timeline is maintained by the base station.

At S720, an SFN-DFN offset can be determined based on the received SFN timeline and a DEN timeline. The DEN timeline is maintained by the relay UE.

At S730, an SFN-DFN offset and a DEN timeline can be transmitted by the relay UE to a remote UE.

At S740, an SFN timeline can be determined based on a received SFN-DFN offset and a received DEN timeline by a remote UE. The process 700 can proceed to S799 and terminate at S799.

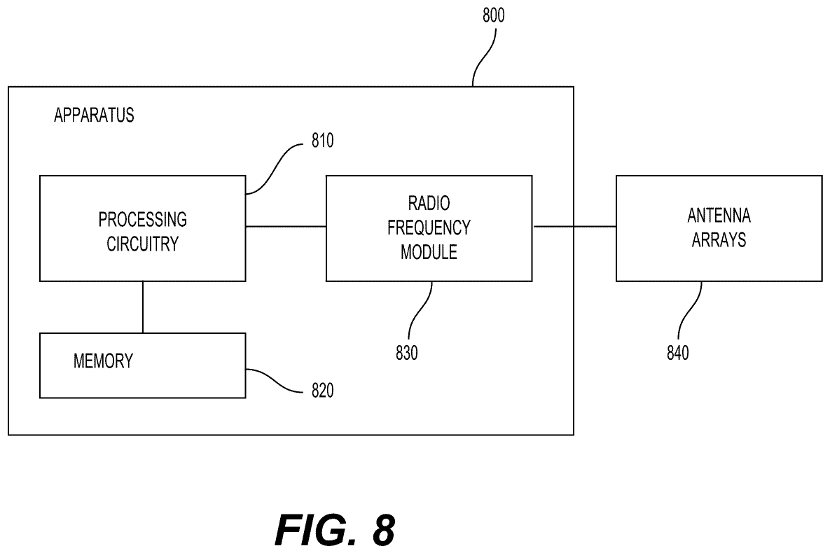

FIG. 8 shows an exemplary apparatus 800 according to embodiments of the disclosure. The apparatus 800 can be configured to perform various functions in accordance with one or more embodiments or examples described herein. Thus, the apparatus 800 can provide means for implementation of mechanisms, techniques, processes, functions, components, systems described herein. For example, the apparatus 800 can be used to implement functions of UEs or base stations in various embodiments and examples described herein. The apparatus 800 can include a general purpose processor or specially designed circuits to implement various functions, components, or processes described herein in various embodiments. The apparatus 800 can include processing circuitry 810, a memory 820, and a radio frequency (RF) module 830.

In various examples, the processing circuitry 810 can include circuitry configured to perform the functions and processes described herein in combination with software or without software. In various examples, the processing circuitry 810 can be a digital signal processor (DSP), an application specific integrated circuit (ASIC), programmable logic devices (PLDs), field programmable gate arrays (FPGAs), digitally enhanced circuits, or comparable devices or a combination thereof.

In some other examples, the processing circuitry 810 can be a central processing unit (CPU) configured to execute program instructions to perform various functions and processes described herein. Accordingly, the memory 820 can be configured to store program instructions. The processing circuitry 810, when executing the program instructions, can perform the functions and processes. The memory 820 can further store other programs or data, such as operating systems, application programs, and the like. The memory 820 can include non-transitory storage media, such as a read only memory (ROM), a random access memory (RAM), a flash memory, a solid state memory, a hard disk drive, an optical disk drive, and the like.

In an embodiment, the RF module 830 receives a processed data signal from the processing circuitry 810 and converts the data signal to beamforming wireless signals that are then transmitted via antenna arrays 840, or vice versa. The RF module 830 can include a digital to analog converter (DAC), an analog to digital converter (ADC), a frequency up converter, a frequency down converter, filters and amplifiers for reception and transmission operations. The RF module 830 can include multi-antenna circuitry for beamforming operations. For example, the multi-antenna circuitry can include an uplink spatial filter circuit, and a downlink spatial filter circuit for shifting analog signal phases or scaling analog signal amplitudes. The antenna arrays 840 can include one or more antenna arrays.

The apparatus 800 can optionally include other components, such as input and output devices, additional or signal processing circuitry, and the like. Accordingly, the apparatus 800 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer-readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer-readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
receiving a system frame number (SFN) from a base station by a first relay UE;
determining a timeline of the SFN based on one or more synchronization signals by the first relay UE;
determining a timeline of a direct frame number (DFN) based on a reference time source by the first relay UE;
computing an SFN-DFN offset based on the difference between the timeline of the SFN and the timeline of the DFN by the first relay UE; and
transmitting the SFN-DFN offset and the DEN to a receiving UE on a sidelink interface.

2. The method of claim 1, wherein the receiving UE is a remote UE.

3. The method of claim 1, wherein the receiving UE is a second relay UE.

4. The method of claim 1, wherein the SFN-DFN offset is transmitted in a message of a PC5 radio resource control (PC5-RRC) protocol.

5. The method of claim 4, wherein the message is an RRCReconfigurationSidelink message.

6. The method of claim 4, wherein the message is an UEAssistanceInformationSidelink message.

7. The method of claim 1, wherein the SFN-DFN offset comprises at least one of a frame-level offset, a subframe-level offset, and a slot-level offset.

8. The method of claim 1, wherein the SFN-DFN offset is transmitted in a medium access control (MAC) control element (CE) of a PC5 MAC protocol.

9. The method of claim 1, wherein the SFN-DFN offset is transmitted in a sidelink control information (SCI) transmission.

10. An apparatus, comprising circuitries configured to:
receive a system frame number (SFN) from a base station by a first relay UE;
determine a timeline of the SFN based on one or more synchronization signals by the first relay UE;
determine a timeline of a direct frame number (DFN) based on a reference time source by the first relay UE;
compute an SFN-DFN offset based on the difference between the timeline of the SFN and the timeline of the DFN by the first relay UE; and
transmit the SFN-DFN offset and the DEN to a receiving UE on a sidelink interface.

11. The system of claim 10, wherein the receiving UE is a remote UE.

12. The system of claim 10, wherein the receiving UE is a second relay UE.

13. The system of claim 10, wherein the SFN-DFN offset is transmitted in a message of a PC5 radio resource control (PC5-RRC) protocol.

14. The system of claim 10, wherein the SFN-DFN offset comprises at least one of a frame-level offset, a subframe-level offset, and a slot-level offset.

15. The system of claim 10, wherein the SFN-DFN offset is transmitted in a medium access control (MAC) control element (CE) of a PC5 MAC protocol.

16. The system of claim 10, wherein the SFN-DFN offset is transmitted in a sidelink control information (SCI) transmission.

17. A non-transitory computer-readable medium storing instructions that, when executed by a processor, cause the processor to perform a method, the method comprising:
receiving a system frame number (SFN) from a base station by a first relay UE;
determining a timeline of the SFN based on one or more synchronization signals by the first relay UE;
determining a timeline of a direct frame number (DFN) based on a reference time source by the first relay UE;
computing an SFN-DFN offset based on the difference between the timeline of the SFN and the timeline of the DFN by the first relay UE; and
transmitting the SFN-DFN offset and the DEN to a receiving UE on a sidelink interface.

18. The non-transitory computer-readable medium of claim 17, wherein the receiving UE is a remote UE.

19. The non-transitory computer-readable medium of claim 17, wherein the receiving UE is a second relay UE.

20. The non-transitory computer-readable medium of claim 17, wherein the SFN-DFN offset comprises at least one of a frame-level offset, a subframe-level offset, and a slot-level offset.
